(19) United States
(12) Patent Application Publication
(10) Pub. No.: US 2025/0101892 A1
(43) Pub. Date: Mar. 27, 2025

(54) SYSTEM AND METHOD FOR SUPPLYING A LUBRICATION POINT WITH LUBRICATING OIL

(71) Applicant: Voith Patent GmbH, Heidenheim (DE)

(72) Inventor: Christopher Jipp, Heidenheim (DE)

(73) Assignee: Voith Patent GmbH, Heidenheim (DE)

(21) Appl. No.: 18/972,235

(22) Filed: Dec. 6, 2024

Related U.S. Application Data
(63) Continuation of application No. PCT/EP2023/061891, filed on May 5, 2023.

(30) Foreign Application Priority Data
Jun. 8, 2022 (DE) 10 2022 114 408.9

(51) Int. Cl. F01M 1/02; F01M 1/10; F01M 5/00; F01M 13/02

(52) U.S. Cl. CPC F01M 1/02; F01M 1/10; F01M 5/001; F01M 5/005; F01M 13/028

(57) ABSTRACT

A system for supplying at least one lubrication point of a machine with lubricating oil includes: a lubricating oil reservoir; a delivery pump; a heat exchanger; a lubrication point; a plurality of lines including a lubricating oil supply line and a lubricating oil return line, the lubrication point being hydraulically connected to the lubricating oil reservoir via the lubricating oil supply line and the lubricating oil return line, a lubricating oil circuit being configured such that the lubricating oil flows through the lubricating oil circuit in one flow direction, the lubricating oil return line including an inlet point which is configured for a protective medium, which is air, being introduced into the lubricating oil return line.

### CROSS REFERENCE TO RELATED APPLICATIONS

This is a continuation of PCT Application No. PCT/EP2023/061891, entitled “SYSTEM AND METHOD FOR SUPPLYING A LUBRICATION POINT WITH LUBRICATING OIL”, filed May 5, 2023, which is incorporated herein by reference. PCT Application No. PCT/EP2023/061891 claims priority to German Patent Application No. 10 2022 114 408.9, filed Jun. 8, 2022, which is incorporated herein by reference.

### BACKGROUND OF THE INVENTION

### 1. Field of the Invention

The present invention relates to lubrication, and, more particularly, to supplying a lubrication point with lubricating oil.

### 2. Description of the Related Art

optionally Devices of this type are known. A central oil lubrication system is described, for example, in DE10 2020 114 316 A1 or in DE 10 2015 224 384 A1. In paper machines, a plurality of roller bearings are, for example, jointly supplied with lubricating oil by way of a central oil lubrication system. During operation of the machine the lubricating oil reaches an operating temperature of 60° C. and absorbs water from the environment during operation until the saturation limit for water in oil is reached. With rising temperature, the saturation limit also rises. This, however, results in the problem of water being released, for example, when the oil cools down during operation due to changed operating conditions or in particular after the machine is shut down into a state of standstill. The water that is then released can lead to corrosion of bearing components or other machine elements, resulting in malfunctions in the entire production line. To counteract this problem, the relative water content in lubricating oil samples taken at different temperatures is measured in the laboratory after start-up of the machine, and reference curves for the relative water content are determined depending on the lubricating oil temperature and oil type. With these reference curves, a sensor is calibrated, and the water content is monitored during operation and checked whether a permissible limit value is reached for this water content, which is highly likely to lead to free water in the lubricating oil when the oil cools. Since the determination of the reference curves is not fully accurate and since also the properties of the lubricating oil change over time, a release of absorbed water in the lubricating oil during machine downtime and lower operational safety can still occur. If the oil is replaced, the expensive and time-consuming procedure for determining the reference curves and programming the sensor must be repeated in order to calibrate the sensor. The saturation limit of water can be 300 ppm for a certain type of lubricating oil at an operating temperature of 60° C., for example, and 200 ppm at a standstill temperature of 20° C. If the oil has reached a water content of 200 ppm at 20° C., the relative water content is 100%. The lubricating oil must be replaced or regenerated to prevent corrosion damage in the lubrication points, even though the saturation limit has not yet been reached in the operating state at 60° C.

Moreover, complex, maintenance-intensive, and expensive cleaning devices or drying systems are often provided in the lubricating oil circuit in order to remove or to extract the absorbed water in the lubricating oil from the lubricating oil. Water separators, for example, are used.

The contaminated lubricating oil can also be replaced with fresh lubricating oil at great cost.

Also, an oil filtration system, in particular for a vacuum pump is known from DE 35 43 978 A1, wherein an oil flushing tank is flushed with an inert gas.

From DE 25 41 616 A1 and US 2003/0 121 491 A1 internal combustion engines are known, wherein the crank chamber of the machines is filled with an inert gas, optionally nitrogen, at a low overpressure, thus preventing penetration of atmospheric oxygen.

From KR 10 2003 044 705 A an automatic cleaning system for an oil filter with nitrogen is known, wherein the cleaning system is arranged in the return line of a lubricating oil system.

What is needed in the art is a device and a method for preventing the penetration of moist air or contaminations into the lubricating oil. What is also needed in the art is to avoid corrosion in lubrication points of a machine, which can be caused by water in the oil. By avoiding possible corrosion, the operational reliability can be increased at low cost. What is also needed in the art is to prevent causative contamination due to the entry of water already at the potential entry points.

### SUMMARY OF THE INVENTION

The present invention relates to a system for supplying at least one lubrication point of a machine with lubricating oil, in particular of a machine for producing, processing and converting of fibrous webs, including the following components that are hydraulically connected via lines to form a lubricating oil circuit: a lubricating oil reservoir; at least one delivery pump; a heat exchanger which is optionally operated with cooling water for the purpose of cooling the circulating lubricating oil; and at least one lubrication point, wherein the at least one lubrication point is, again, hydraulically connected to the lubricating oil reservoir via a line, and wherein the lubricating oil flows through the lubricating oil circuit in one flow direction. The present invention also relates to a method for supplying at least one lubrication point of a machine with lubricating oil.

A system for supplying lubricating oil to at least one lubrication point of a machine, in particular a machine for the production, processing and conversion of fibrous webs, is proposed, including the following components that are hydraulically connected via lines to form a lubricating oil circuit: a lubricating oil reservoir; at least one delivery pump; a heat exchanger which is optionally operated with cooling water for the purpose of cooling the circulating lubricating oil; and at least one lubrication point, wherein the at least one lubrication point is, again, hydraulically connected to the lubricating oil reservoir via a line, and wherein the lubricating oil flows through the lubricating oil circuit in one flow direction.

The present invention is characterized in that, the lubricating oil return line includes an inlet point, which is designed in such a way that a protective medium, which is air, can be introduced into the lubricating oil return line.

This solution makes it possible to introduce air as a protective medium into the at least one lubricating oil return line and to pressurize the lubricating oil return line up to the lubrication point with an operating pressure or an overpressure vis-à-vis the atmospheric pressure and/or a volume flow. As a result, the lubrication point connected to the at least one lubricating oil return line is also subjected to an operating pressure and/or volume flow. This makes it possible to prevent contaminants such as moist ambient air, steam, or foreign substances from entering or penetrating the lubricating oil at the at least one lubrication point with respect to the surrounding atmosphere. The lubrication point is usually provided with at least one seal against the environment, such as a labyrinth seal, through which impurities can enter during normal operation.

By introducing a protective medium, a slight overpressure or volume flow, optionally an air flow, can be generated at the lubrication points and their seals, which is sufficient to reduce and/or prevent entry of contaminants.

In one practical case, the inlet point is connected to a protective medium line, and the inlet point and/or the protective medium line includes a protective medium control valve.

The at least one lubricating point can include an antifriction bearing and/or a sliding bearing and/or a gear drive.

In one practical case, the lubricating oil circuit may include at least one heating device for heating the lubricating oil and/or a cleaning device for cleaning the lubricating oil. The heating device can include a heat exchanger. Heating of the lubricating oil is optionally implemented during the restart of the machine from standstill into the operating condition.

The cleaning device is suitable to remove absorbed water and other contaminants from the lubricating oil.

Viewed in flow direction, it can be advantageous if the lubricating oil return line includes a siphon before the lubricating oil returns into the lubricating oil reservoir.

In one practical case, the inlet point is arranged before the siphon in the direction of flow of the lubricating oil.

The siphon thereby provides a protective medium seal vis-à-vis the lubricating oil reservoir. The construction height of the siphon or the accumulation height of the siphon has a limiting effect on the possible operating pressure of the protective medium (air) introduced into the return lines. The leg length of the siphon must thus be adapted to the desired operating pressures of the protective medium that is to be introduced.

In one advantageous further development, the lubricating oil circuit can be a lubricating oil circuit that is open to the surrounding atmosphere.

In one practical case, the lubricating oil return line from the lubrication point to the lubricating oil reservoir, optionally to the siphon, can be a lubricating oil circuit that is partially open to the surrounding atmosphere. This means that the lubricating oil return line from the siphon to the lubrication point is only partially filled with lubricating oil, optionally up to a maximum of 75%, in particular 50%, and that the remaining part is taken up by the ambient air. This advantageously enables the lubricating oil return line to be easily impacted with a protective medium, optionally air. The introduction of a protective medium, for example pressurized air—compressed air—into the lubricating oil return line creates an overpressure vis-à-vis the environment, wherein even low overpressures are sufficient to impact lubrication points located higher (static pressure) in the machine for the production of the fibrous web with an overpressure vis-à-vis the environment.

In one advantageous further development, the lubricating oil return line can include a check valve which is arranged in a way that the protective medium is prevented from escaping, while simultaneously supporting the lubricating oil return.

The check valve makes it possible to design the lubricating oil return line in such a way that an operating pressure cannot escape from the inside to the environment, but that, however, an unwanted negative pressure—for example due to recycling oil—in the lubricating oil return line is prevented.

In one practical case, the lubricating oil return line may include at least one sealed ventilation device. The introduction of the protective medium makes it necessary to seal off any existing ventilation devices from the environment when updating existing systems. This also has the advantage of preventing contaminations from entering via the ventilation devices.

The present invention also provides a method for operating a system for the supply of lubricating oil to at least one lubrication point of a machine, in particular a machine for the production, processing and converting of fibrous webs. The system includes the following components, which are connected via lines to a lubricating oil circuit: an oil reservoir; at least one feed pump; a heat exchanger for cooling the circulating lubricating oil; and at least one lubrication point, wherein the at least one lubrication point is again hydraulically connected with the oil reservoir, and wherein the lubricating oil flows through the lubricating oil circuit in one flow direction.

According to the present invention, it is provided that a protective medium line and an inlet point are provided in the lubricating oil return line and that the lubricating oil return line is thereby supplied and regulated with a protective medium—which is air—at an operating pressure or overpressure vis-à-vis the atmospheric pressure and/or a volume flow.

In some practical cases, the adjustment of an advantageous operating pressure to obtain the protective effect against moist air, steam and/or contaminants is difficult. This is often the case in complex and branched lubricating oil circuits and is due to the pressure losses in the piping system that are difficult to determine.

Therefore, as an alternative arrangement, no fixed operating pressure is set at the inlet point, but instead a defined volume flow of the protective medium or protective media optionally of air is introduced and adjusted. This volume flow is monitored and regulated at the inlet point. This ensures that the protective medium flows safely into the return lines of the lubricating oil circuit, thus providing a flow opposing the entry of moist air, steam, or other impurities.

The protective medium is advantageously introduced and regulated at an operating pressure of 0.01 bar to 0.1 bar, optionally 0.02 bar to 0.05 bar, above the ambient pressure. Even small overpressures compared to the ambient pressure make it possible to prevent contaminants from penetrating into the at least one lubrication point.

The protective medium is advantageously introduced and regulated with a volume flow, depending on the operating pressure to be set, the dimensions of the lubricating oil circuit and the lubrication points that are to be supplied.

In one possible practical case, the protective medium is introduced and regulated with an operating pressure and/or with a volume flow after reaching a lubricating oil temperature of 40° C. to 80° C., optionally of 50° C. to 65° C.

In one possible practical case, the protective medium is introduced and regulated with an operating pressure of 0 bar and/or with a volume flow of 0 m³/s, optionally that is, without pressure and/or flow, during a start-up process and/or a standstill of the machine.

Additional features and advantages of the invention result from the following description of an optional design example, with reference to the drawing.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawing, wherein:

FIG. 1 is a flow diagram of a system for supplying at least one lubrication point of a machine with lubricating oil.

Corresponding reference characters indicate corresponding parts throughout the several views. The exemplification set out herein illustrates at least one embodiment of the invention, and such exemplification is not to be construed as limiting the scope of the invention in any manner.

### DETAILED DESCRIPTION OF THE INVENTION

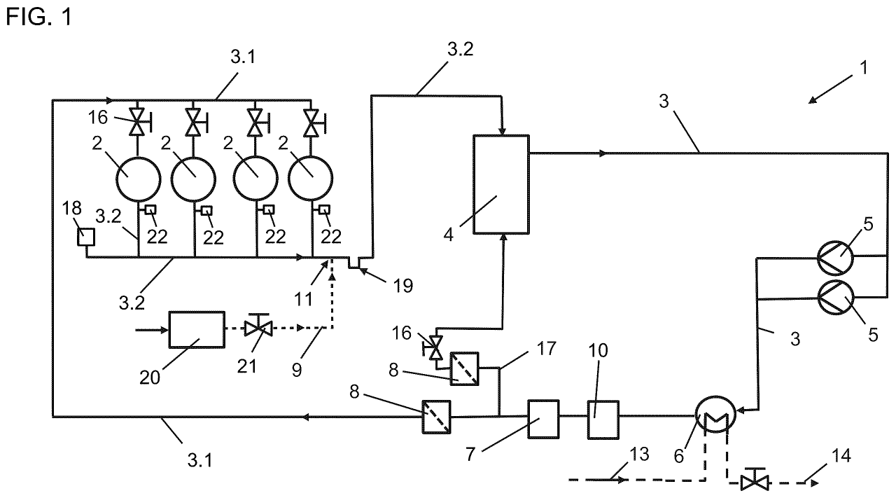

The only FIGURE, FIG. 1, shows a flow diagram of a system 1 for supplying at least one lubrication point 2 of a machine with lubricating oil. This example features a machine for producing, processing, and converting a fibrous web. In paper machines of this type, system 1 supplies a plurality of positions of rollers—of which only four are shown here for the sake of simplicity—with lubricating oil via a central oil lubrication system. Lubrication points 2 are in part exposed to extreme temperatures and high humidity. The dryer section in particular is subject to high temperatures, high humidity, and a vaporous atmosphere. The humidity can accumulate in the lubricating oil until a saturation limit is reached through condensation processes. As the saturation limit is temperature-dependent, cooling of the lubricating oil during operation and especially when the machine is shut down can lead to the release of water and thus to corrosion in the bearing points. Additional contaminants can also enter the lubricating oil through lubrication points 2. The design of system 1 according to FIG. 1 can remedy this problem and prevent entry or contamination of the lubricating oil.

System 1 includes the following components that are hydraulically connected via lines to form a lubricating oil circuit 3: a lubricating oil reservoir 4; at least one delivery pump 5, wherein in this example two delivery pumps 5 are provided to generate a lubricating oil flow in the direction of flow of lubricating oil circuit 3; a heat exchanger 6 which is operated with cooling water for the purpose of cooling the circulating lubricating oil during operation of the machine; and, in this example, four lubrication points 2. These are again hydraulically connected via metal lines or tubes with lubricating oil reservoir 4. Lubrication points 2 are optionally supplied via at least one lubricating oil feed line 3.1, and the lubricating oil supply to individual lubrication points 2 is controlled via at least one corresponding control valve 16.

Originating from the at least one lubrication point 2, lubricating oil circuit 3 includes at least one lubricating oil return line 3.2 for each lubrication point 2. Advantageously, in this example, four lubricating oil return lines 3.2 originating from lubrication points 2 are fed into a common lubricating oil return line 3.2 after a short line section.

Lubricating return line 3.2 leads back again to lubricating oil reservoir 4.

Moreover, lubricating oil return line 3.2 includes an inlet point 11 through which a protective medium, optionally air, can be introduced into lubricating oil return line 3.2. The protective medium can be provided by a pressure system of the machine for the production of a fibrous web or can be provided by separate compressors. Alternatively, the protective medium can be stored under overpressure in a protective medium reservoir 20. Moreover, lubricating oil return line 3.2 is connected with protective medium reservoir 20 and/or a compressor and/or a pressure system of the machine for producing a fibrous web via inlet point 11 and a protective medium line 9. Protective medium line 9 also includes a control unit which can regulate a desired operating pressure or overpressure vis-à-vis the surrounding atmospheric pressure and/or a volume flow or flow rate via a protective medium control valve 21. Protective medium control valve 21 can alternatively also be designed as a measuring and control unit for a pressure or flow rate.

At inlet point 11, the protective medium is introduced into lubricating oil return line 3.2 with an operating pressure or overpressure vis-à-vis the atmospheric pressure. Inlet point 11 is located advantageously between the at least one lubrication point 2 and a siphon 19 which is located in lubricating oil return line 3.2. Furthermore, it is optional that inlet point 11, with which the protective medium is introduced, is located in the direction of flow directly before siphon 19.

Lubricating oil circuit 3 is designed, for example, as a partially open system with respect to the environment. This means that lubricating oil return line 3.2, originating from lubrication point 2 to lubricating oil reservoir 4, optionally up to a siphon 19 that is included in the direction of flow in front of lubricating oil reservoir 4, is only partially filled with oil.

Siphon 19 included in lubricating oil return line 3.2 is arranged before lubricating oil reservoir 4 in the direction of flow of the lubricating oil so that the siphon forms a seal against the introduced protective medium and does not pressurize lubricating oil reservoir 4 with excess pressure or operating pressure. The height of siphon 19 or the accumulation height of siphon 19 has a limiting effect on the possible operating pressure of protective medium line 9. The leg length of siphon 19 must thus be adapted to the desired operating pressures.

The open system in the at least one lubricating oil return line 3.2 means, moreover, that no static lubricating oil column with corresponding static pressure can form, against which the overpressure of the protective medium, which is set as an operating pressure, must act. The protective medium must therefore only act against the ambient air pressure in lubricating oil return lines 3.2.

Lubrication points 2 are for example antifriction bearings, sliding bearings and/or gear drives for the drive and/or the bearings of rollers or other rotating components used in the machine for the production of a fibrous web. Lubrication points 2 designed in this way are sealed against the environment or the surrounding atmosphere with seals, for example with labyrinth seals. Generally, these seals are never 100% tight.

FIG. 1 also shows a design in which a check valve 18 is included in lubricating oil return line 3.2. Said check valve 18 is arranged in lubricating oil return line 3.2 in such a way that a set operating pressure cannot escape from the inside to the environment; however, an unwanted negative pressure in lubricating oil return line 3.2 is prevented.

This example also illustrates at least one ventilation device 22 per lubrication point 2. This is included in the at least one lubricating oil return line 3.2. Furthermore, ventilation device 22 is usually included in existing machines for the production of a fibrous web in order to avoid possible negative pressure due to the flowing lubricating oil in lubricating oil return lines 3.2. In the case of refurbishments and upgrades by the present invention, ventilation devices 22 are to be removed by appropriate ways or sealed off from the environment. This has the additional advantage that no further contaminants are introduced into the system through this open location.

Heat exchanger 6 is connected to a coolant inlet 13 and a coolant return 14. As previously mentioned, water is used as a coolant. Located after heat exchanger 6 in direction of flow is heating device 7, which may also include a heat exchanger, followed by a branch to bypass line 17 for rapid heating of the lubricating oil to operating temperature. After an optional filter 8, bypass line 17 flows into lubricating oil reservoir 4. With bypass line 17, a heating operation of system 1 is feasible with a smaller lubricating oil circuit 3. To achieve the desired temperature, bypass line 17 also includes a control or regulating unit, which can regulate heating via a control valve 16. Optionally, an alternative arrangement in lubricating oil circuit 3 may include a cleaning device 10 for the removal of contaminants such as the absorbed water or other foreign substances. This also prevents the formation of free water in lubrication points 2 and consequently corrosion. For further removal of dirt particles in the lubricating oil, an additional filter 8 is provided in lubricating oil circuit 3.

### COMPONENT IDENTIFICATION LISTING

1 System
2 Lubrication point
3 Lubricating oil circuit
3.1 Lubricating oil supply line
3.2 Lubricating oil return line
4 Lubricating oil reservoir
5 Feed pump
6 Heat exchanger
7 Heating device
8 Filter
9 Protective medium line
10 Cleaning device
11 Inlet point
13 Coolant inlet
14 Coolant return
16 Control valve
17 Bypass line
18 Check valve
19 Siphon
20 Protective medium reservoir
21 Protective medium control valve
22 Ventilation device

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for supplying at least one lubrication point of a machine with a lubricating oil, the system comprising:
a lubricating oil reservoir;
at least one delivery pump;
a heat exchanger;
at least one lubrication point;
a plurality of lines, the lubricating oil reservoir, the at least one delivery pump, the heat exchanger, and the at least one lubrication point being hydraulically connected with one another via the plurality of lines such that the lubricating oil reservoir, the at least one delivery pump, the heat exchanger, the at least one lubrication point, and the plurality of lines form a lubricating oil circuit, the plurality of lines including a lubricating oil supply line and a lubricating oil return line, the at least one lubrication point being hydraulically connected to the lubricating oil reservoir via the lubricating oil supply line and the lubricating oil return line, the lubricating oil circuit being configured such that the lubricating oil flows through the lubricating oil circuit in one flow direction, the lubricating oil return line including an inlet point which is configured for a protective medium, which is air, being introduced into the lubricating oil return line.

2. The system according to claim 1, further including a protective medium line, wherein the inlet point is connected to the protective medium line, and at least one of the inlet point and the protective medium line includes a protective medium control valve.

3. The system according to claim 1, wherein the lubricating oil circuit includes at least one of (a) at least one heating device configured for heating the lubricating oil and (b) at least one cleaning device configured for cleaning the lubricating oil.

4. The system according to claim 1, wherein the lubricating oil return line includes a siphon positioned before the lubricating oil reservoir in the flow direction and thus before the lubricating oil returns into the lubricating oil reservoir when the lubricating oil is circulating.

5. The system according to claim 4, wherein the inlet point is arranged before the siphon in the flow direction of the lubricating oil.

6. The system according to claim 1, wherein the lubricating oil circuit is open to a surrounding atmosphere.

7. The system according to claim 1, the lubricating oil return line from the at least one lubrication point to the lubricating oil reservoir is a part of the lubricating oil circuit that is partially open to a surrounding atmosphere.

8. The system according to claim 1, wherein the lubricating oil return line includes a siphon positioned before the lubricating oil reservoir in the flow direction and thus before the lubricating oil returns into the lubricating oil reservoir when the lubricating oil is circulating, wherein the lubricating oil return line from the at least one lubrication point to the siphon is a part of the lubricating oil circuit that is partially open to a surrounding atmosphere.

9. The system according to claim 1, wherein the lubricating oil return line includes a check valve which is structured and arranged such that the protective medium is prevented from escaping while simultaneously supporting the lubricating oil return.

10. The system according to claim 1, wherein the lubricating oil return line includes at least one ventilation device, which is sealed.

11. The system according to claim 1, wherein the machine is configured for producing, processing, and converting a web of fibrous material.

12. The system according to claim 1, wherein the heat exchanger is configured for being operated with a cooling water in order to cool the lubricating oil which is circulating.

13. A method for operating a system for supplying at least one lubrication point of a machine with a lubricating oil, the method comprising the steps of:
providing that the system includes:
a lubricating oil reservoir;
at least one delivery pump;
a heat exchanger configured for cooling the lubricating oil which is circulating;
at least one lubrication point;
a plurality of lines, the lubricating oil reservoir, the at least one delivery pump, the heat exchanger, and the at least one lubrication point being hydraulically connected with one another via the plurality of lines such that the lubricating oil reservoir, the at least one delivery pump, the heat exchanger, the at least one lubrication point, and the plurality of lines form a lubricating oil circuit, the plurality of lines including a lubricating oil return line, the at least one lubrication point being hydraulically connected to the lubricating oil reservoir, the lubricating oil circuit being configured such that the lubricating oil flows through the lubricating oil circuit in one flow direction, the lubricating oil return line including an inlet point which is configured for a protective medium, which is air, being introduced into the lubricating oil return line; and
introducing, and regulating, the protective medium at an operating pressure vis-à-vis at least one of an atmospheric pressure and a volume flow.

14. The method according to claim 13, wherein the protective medium is introduced and regulated at the operating pressure of 0.01 bar to 0.1 bar above the atmospheric pressure.

15. The method according to claim 13, wherein the protective medium is introduced and regulated at the operating pressure of 0.02 bar to 0.05 bar above the atmospheric pressure.

16. The method according to claim 13, wherein the protective medium is introduced and regulated at least one of with the operating pressure and with the volume flow after reaching a lubricating oil temperature of 40° C. to 80° C.

17. The method according to claim 13, wherein the protective medium is introduced and regulated at least one of with the operating pressure and with the volume flow after reaching a lubricating oil temperature of 50° C. to 65° C.

18. The method according to claim 13, wherein the machine is configured for producing, processing, and converting a web of fibrous material.
